(19) United States
(12) Patent Application Publication
(10) Pub. No.: US 2019/0030703 A1
(43) Pub. Date: Jan. 31, 2019

(54) HAND TOOL HANDLE

(71) Applicant: Eugene EMERSON, Whittier, CA (US)

(72) Inventor: Eugene EMERSON, Whittier, CA (US)

(21) Appl. No.: 15/659,295

(22) Filed: Jul. 25, 2017

(51) Int. Cl. B25G 3/28; B25G 3/06; B25G 1/06; B25G 1/10

(52) U.S. Cl. CPC B25G 3/28; B25G 1/105; B25G 1/063; B25G 3/06

(57) ABSTRACT

A hand tool handle includes a main body, first and second installation holes, and a detachable tool holder. The main body has a side wall portion and first and second edge portions. The first installation hole is provided at the side wall portion, and the second installation hole is provided at the first edge portion. The first and second installation holes are provided with adjacent locating detents. The detachable tool holder has a latching portion and a tool insertion hole. The latching portion of the detachable tool holder is configured to be inserted and held in the first installation hole or the second installation hole, and the tool insertion hole is configured to receive an external tool. The main body may have substantially a shape of cylinder or faceted polygon cylinder.

### BACKGROUND OF THE INVENTION

The present invention relates to a hand tool handle.

Conventional tool handle was simple in structure and therefore in function.

There are situations, in which a tool must be used in different environment, sometimes spacious vertically or horizontally only.

In such cases, the tool needs to be held securely to a versatile handle. Otherwise, a single tool may need a couple of holders that accustomed to such plurality of situations.

However, it would be very inconvenient to provide and carry around a multiple number of handles for a tool, especially when more than one tool are needed for a job.

Accordingly, a need for a hand tool handle has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a hand tool handle, which can be accustomed to many environments.

An aspect of the invention provides a hand tool handle, which comprises a main body, first and second installation holes, and a detachable tool holder.

The main body has a side wall portion and first and second edge portions.

The first installation hole is provided at the side wall portion, and the second installation hole is provided at the first edge portion and/or at the second edge portion.

The detachable tool holder has a latching portion and a tool insertion hole.

The latching portion of the detachable tool holder is configured to be inserted and held in the first installation hole or the second installation hole, and the tool insertion hole is configured to receive an external tool.

The main body may have substantially a shape of cylinder.

The main body may have a shape of hexagonal cylinder having six side surfaces or be comprised of faceted or partially faceted sides so as to accommodate an installation hole on the flat of a facet.

The first installation hole may be provided in one of the facet surfaces of the main body that run on the length of the broadly cylindrical main body.

Each of the first and second installation holes may be formed in the main body or machined in the main body after forming.

Each of the first and second installation holes may be made of metal. The main body may be made of plastic, metal or other formable material.

A part of metal portion of the first or second installation holes may be embedded and fastened in the plastic, metal or other formable material portion of the main body.

The latching portion of the detachable tool holder may comprise a snap-on fit portion and two or more rotation-preventing protrusions.

The snap-on fit portion is provided on the latching portion and configured for fitting on and holding on a counter-part provided in the first or second installation hole.

The two or more rotation-preventing protrusions are provided on the latching portion and configured for engaging with corresponding grooves provided in the first and second installation hole and preventing a rotational movement of the detachable tool holder with respect to the main body. The rotation-preventing protrusions can be effectively reversed to equal effect that is the protrusions can be within the installation hole with corresponding grooves provided on the tool holder.

The surface on the main body surrounding the first and second installation holes may comprise locating detents which align with the position of the rotation-preventing protrusions or groves of the installation holes.

The latching portion of the detachable tool holder may comprise male threads, and the first or second installation hole comprises female threads corresponding to the male threads.

The tool insertion hole of the detachable tool holder may comprise a faceted hole to accept a tool with a mating faceted shape. The tool insertion hole may be magnetic.

The advantages of the present invention are: (1) The hand tool handle according to the invention has two-way installation directions; and (2) The hand tool handle according to the present invention provides each rotation grips in both directions. (3) The hand tool handle according to the present invention has ease of alignment to the tool holder.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a hand tool handle according to an embodiment of the invention;

FIG. 2 is a top plan view showing the hand tool handle of FIG. 1;

FIG. 3 is another perspective view showing the hand tool handle of FIG. 1;

FIG. 4 is a perspective view showing the hand tool handle with the detachable tool holder installed in a first direction according to an embodiment of the invention;

FIG. 5 is another perspective view showing the hand tool handle with the detachable tool holder and a tool bit installed according to an embodiment of the invention; and

FIG. 6 is still perspective view showing the hand tool handle with the detachable tool holder installed in a second direction according to another embodiment of the invention

### DETAILED DESCRIPTION EMBODIMENTS OF THE INVENTION

Referring to the figures, the embodiments of the invention are described in detail.

An object of the invention is to provide a hand tool handle, which can be accustomed to many environments.

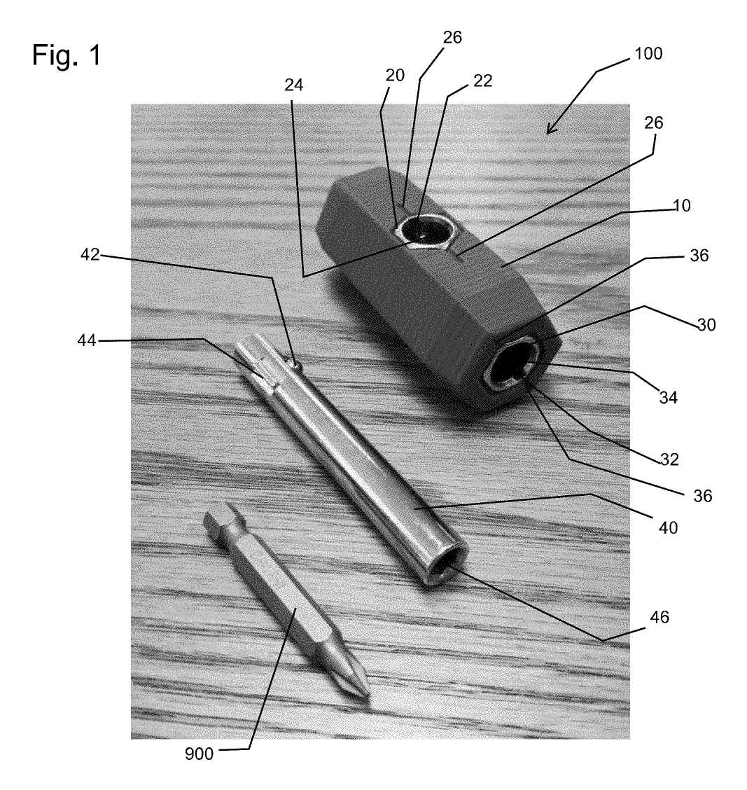

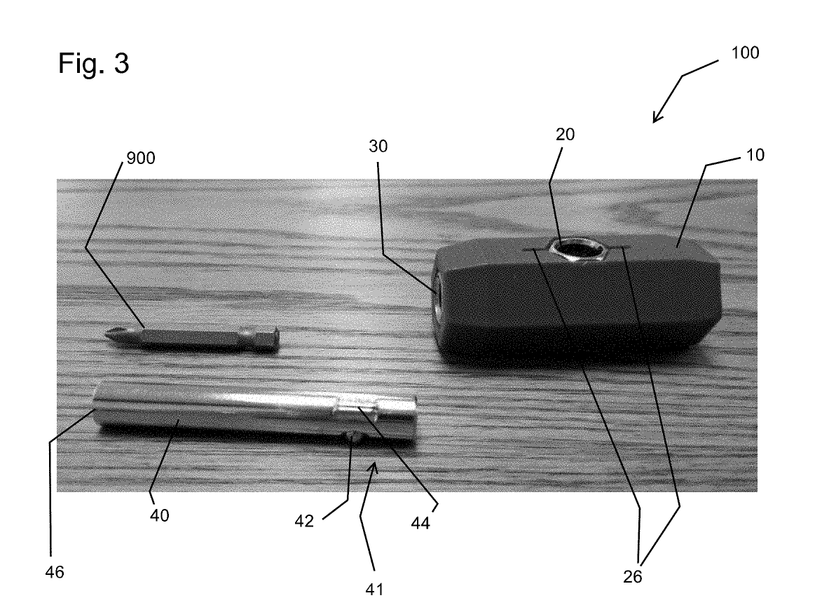

FIGS. 1 to 3 show a hand tool handle (100) according to an embodiment of the invention, along with a tool bit (900), for an example.

An aspect of the invention provides the hand tool handle (100), which comprises a main body (10), first and second installation holes (20, 30), and a detachable tool holder (40).

The main body (10) has a side wall portion and first and second edge portions as shown in FIG. 1.

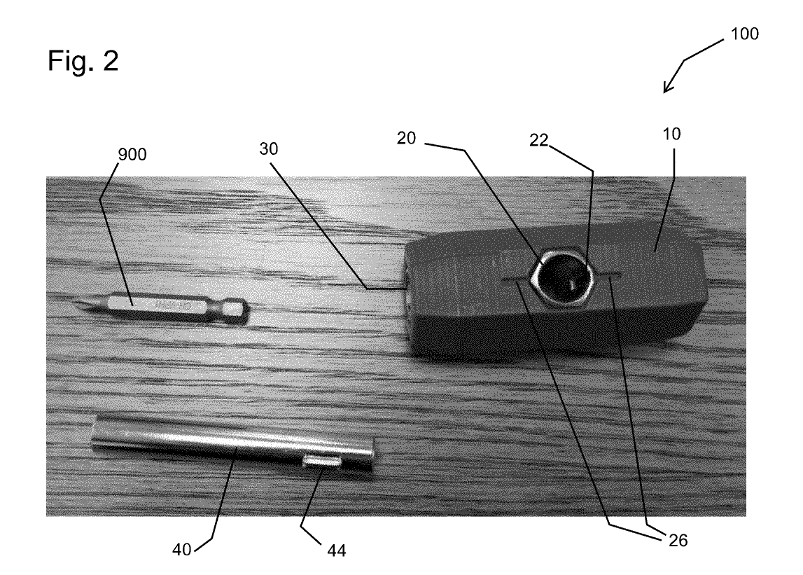

The first installation hole (20) is provided at the side wall portion, and the second installation hole (30) is provided at the first edge portion as shown in FIGS. 1 and 2.

The detachable tool holder (40) has a latching portion (41) and a tool insertion hole (46) as shown in FIGS. 1, 2, and 3.

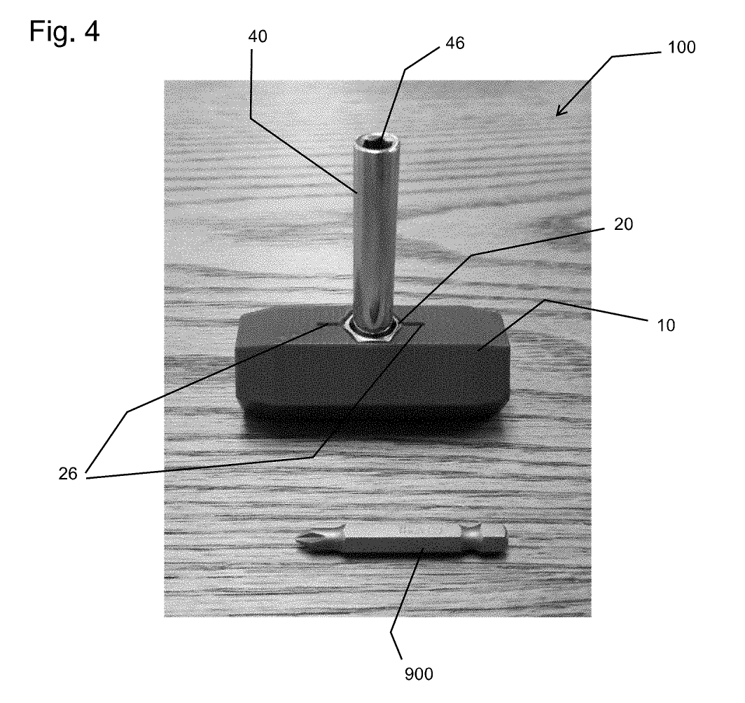

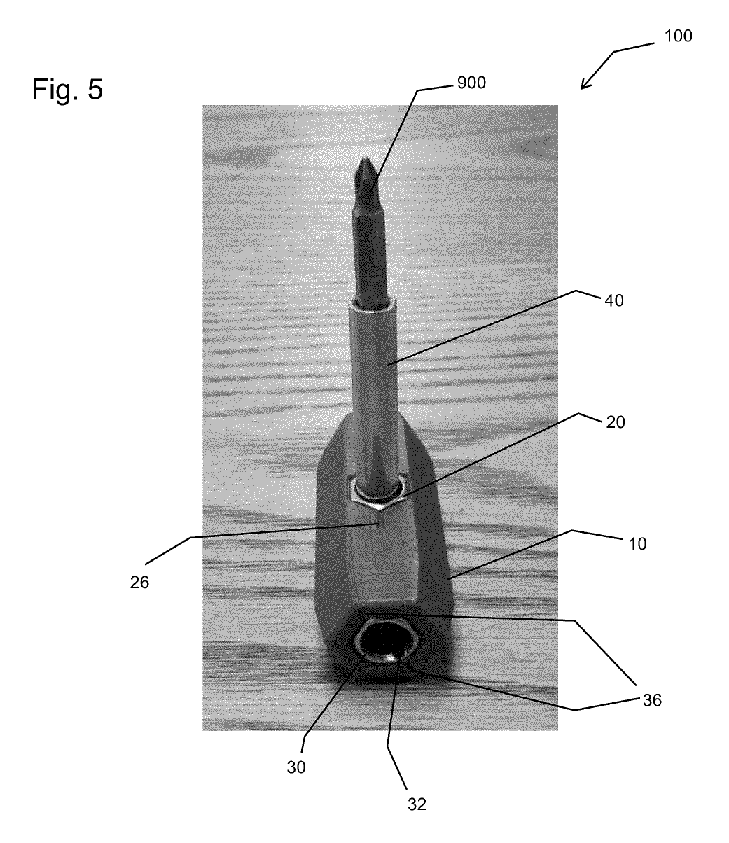

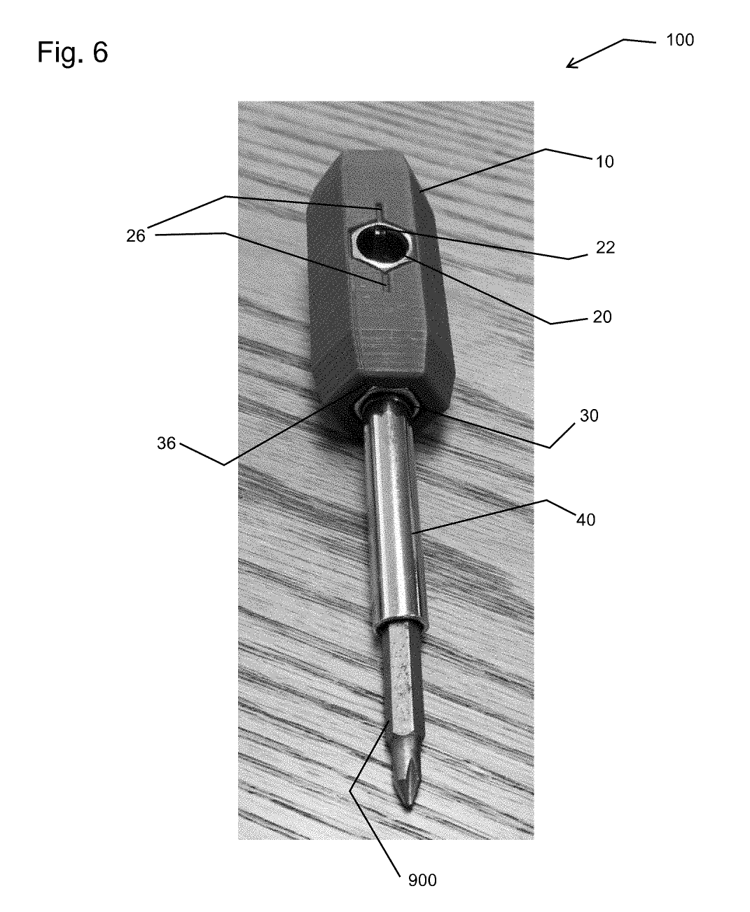

The latching portion (41) of the detachable tool holder (40) is configured to be inserted and held in the first installation hole (20) or the second installation hole (30), and the tool insertion hole (46) is configured to receive an external tool (900) as shown in FIGS. 4, 5, and 6.

The main body (10) may have substantially a shape of cylinder.

Preferably, the main body (10) may have a shape of a faceted polygon having multiple side surfaces as shown in FIGS. 1-6. Of course, the cross-sectional shape is not limiting. As long as it works as a handle for rotating the detachable tool holder (40), the main body (10) may have any shape of cross-section.

The first installation hole (20) may be provided in one of the facet side surfaces of the main body (10) as shown in FIGS. 1-6.

Each of the first and second installation holes (20, 30) may be made of metal. The main body (10) may be made of plastic, metal or other formable material as shown in FIGS. 1-6.

A part of metal portion of the first or second installation holes (20, 30) may be embedded and fastened in the plastic, metal or formable material of the portion of the main body (10).

The latching portion (41) of the detachable tool holder (40) may comprise a snap-on fit portion (42) and two or more rotation-preventing protrusions (44) as shown in FIGS. 1-3.

The snap-on fit portion (42) is provided on the latching portion (41) and configured for fitting on and holding on a counter-part (24, 34) provided in the first or second installation hole (20, 30).

The two or more rotation-preventing protrusions (44) are provided on the latching portion (41) and configured for engaging with corresponding grooves (22, 32) provided in the the first or second installation hole (20, 30) and preventing a rotational movement of the detachable tool holder (40) with respect to the main body (10) as shown in FIGS. 1 and 2.

The external surface of the main body adjacent to the first and second installation holes (20 and 30) may comprise locating detents (26, 36). The detents may match in number of and align with the rotation preventing groves (22, 32) of the first and second installation holes (20,30).

Alternatively, the latching portion (41) of the detachable tool holder (40) may comprise male threads (not shown), and the first or second installation hole (20, 30) comprises female threads (not shown) corresponding to the male threads, so that the male and female threads engage with each other, and fix the external tool securely in the first or second installation hole (20, 30).

The tool insertion hole (46) of the detachable tool holder (40) may comprise a faceted polygon shaped hole as shown in FIGS. 1 and 4. The tool insertion hole (46) may be magnetic, facilitating the engagement and fixing of an external tool (900) to the tool insertion hole (46).

In FIG. 1, the snap-on fit (42) is provided by a metal ball installed with a spring, so that the ball can be pushed in by an external force applied on any spot of the exposed hemi-sphere and the detachable tool holder (40) can be pushed in to the first or second installation hole (20, 30) and fixed and held with a click and pulled out later by another external pulling force larger than a predetermined magnitude. The counter-part (24, 34) is not shown clearly except for the position to be installed in the first or second installation hole (20, 30), but the shape and operational principle of the snap-on fit (42) and the count-part (24, 34) are well known to the community.

In FIG. 2, the main body (10) of a faceted cylinder may further have a slanted edge portions provided on both ends of the main body (10), which may facilitate the grip of the hand tool handle (100).

In FIG. 4, the detachable tool holder (40) is installed in the first installation hole (20) and ready to receive the external tool (900) at the tool insertion hole (46).

As shown in FIGS. 4-6, the external tool (900) can be, by way of the detachable tool holder (40), installed and used in the first and second directions.

In certain embodiments of the invention, the second installation hole (30) can be provided on both edge portions of the main body (10).

In certain embodiments of the invention, the first installation hole (20) can be provided on multiple positions of a single or multiple facets of the main body (10).

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A hand tool handle comprising:
a main body having a side wall portion and first and second edge portions;
a first installation hole provided at the side wall portion;
a second installation hole provided at the first edge portion; and
a detachable tool holder having a latching portion and a tool insertion hole,
wherein the latching portion of the detachable tool holder is configured to be inserted and held in the first installation hole or the second installation hole, and
wherein the tool insertion hole is configured to receive an external tool.

2. The hand tool handle of claim 1, wherein the main body has substantially a shape of cylinder.

3. The hand tool handle of claim 2, wherein the main body has a shape of a faceted polygon cylinder having multiple side surfaces.

4. The hand tool handle of claim 3, wherein the first installation hole is provided in one of the facet side surfaces of the main body.

5. The hand tool handle of claim 1, wherein each of the first and second installation holes is made of metal.

6. The hand tool handle of claim 5, wherein the main body is made of plastic, metal, or other formable material.

7. The hand tool handle of claim 6, wherein a part of metal portion of the first or second installation holes is embedded and fastened in the plastic, metal, or other formable material portion of the main body.

8. The hand tool handle of claim 1, wherein the latching portion of the detachable tool holder comprises:
a snap-on fit portion provided on the latching portion and configured for fitting on and holding on a counter-part provided in the first or second installation hole; and
two or more rotation-preventing protrusions provided on the latching portion and configured for engaging with corresponding grooves provided in the the first or second installation hole and preventing a rotational movement of the detachable tool holder with respect to the main body.

9. The hand tool handle of claim 1, wherein the latching portion of the detachable tool holder comprises male threads, and the first and/or second installation hole comprises female threads corresponding to the male threads.

10. The hand tool handle of claim 1, wherein the tool insertion hole of the detachable tool holder comprises a faceted polygon shaped hole.

11. The hand tool handle of claim 10, wherein the tool insertion hole is magnetic.

12. The hand tool handle of claim 1, wherein each of the first and second installation holes comprises adjacent locating detents.
